(19) United States
(12) Patent Application Publication
(10) Pub. No.: US 2012/0202184 A1
(43) Pub. Date: Aug. 9, 2012

(54) METHOD AND DEVICE FOR SELECTING EXERCISES

(75) Inventors: Anouk Charlotte O'Prinsen, Shanghai (CN); Xi Chen, Shanghai (CN)

(73) Assignee: KONINKLIJKE PHILIPS ELECTRONICS N.V., EINDHOVEN (NL)

(21) Appl. No.: 13/501,311

(22) PCT Filed: Oct. 12, 2010
(86) PCT No.: PCT/IB10/54604

§ 371 Date: Apr. 11, 2012

(30) Foreign Application Priority Data
Oct. 28, 2009 (CN) 200910174414.5

(51) Int. Cl. G09B 5/00

(52) U.S. Cl. 434/322

(57) ABSTRACT

To provide a fast and systematic selection of exercises for a training plan of a user, the invention proposes a method and device for selecting exercises, each of a plurality of exercises (E1 to E5) being associated with a set of characteristics, and each characteristic of the set of characteristics being associated with a set of categories (C1 and C2) for classifying the plurality of exercises, the method comprising the steps of: A. selecting, according to input reflecting answers to a first set of questions related to a given characteristic among said set of characteristics, a subset of categories (C1) from a set of categories (C1 and C2) which is associated with said given characteristic, wherein said answers to the first set of questions reflect information of said user; B. determining a set of exercises based on said selected subset of categories (C1). The method takes each category as a whole and selects proper categories, and then determines proper exercises from the exercises in the determined proper categories. The present invention enables the proper exercises to be obtained faster and more systematically as compared to selecting the proper exercise from a number of exercises by checking them one by one.

### TECHNICAL FIELD

The present invention relates to the determination of a training plan, and particularly to the selection of exercises intended to be done by users.

### BACKGROUND

Serious illnesses such as a stroke, or surgical operations such as the insertion of joint implants may be the cause of disability of a user. For example, after a stroke, the region of the brain responsible for controlling a muscle or a number of muscles in a functional chain, may be damaged. Thus, the affected muscles degenerate. The user should do exercises to train the affected muscles and joints in order to, at least partially, restore the lost functions. The problem encountered here is how to determine the proper exercises to be done by the user in his training plan according to his current health state.

U.S. patent application with publication number US 2004/0038190 A1 discloses a method and a system to determine the exercises by firstly evaluating the user's capacity profile to obtain his capability deficits, and secondly selecting the exercises to be done according to his capability deficits, based on expert rules. However, this technique deals with capability deficits in a qualitative way; thus, it might not obtain the proper high-quality exercises in an accurate way.

### SUMMARY OF THE INVENTION

Currently, answers to clinical verified questions, such as clinical scales, are used to measure the current health state of a user in multiple aspects in a quantitative way. These answers are updated as the user's health states vary; therefore the doctor or the therapist could determine the progress of the health state of the user during a certain period of time, by studying the variation of the score in the scales of the user during that period. The answers to clinical verified questions are suitable for being used to determine the exercises to be done in the training plan of the user. In order to obtain exercises suitable for the user, from a plurality of exercises, however, a number of different answers to different questions need to be combined in a systematic way, which is very time-consuming and hardly possible to be done manually by the doctor or the therapist.

To address this concern, in a first aspect of the present invention, there is provided a method of selecting exercises from a plurality of exercises for a user, each of said plurality of exercises being associated with a set of characteristics, and each characteristic of said set of characteristics being associated with a set of categories for classifying said plurality of exercises, the method comprising the steps of: A. selecting, according to input reflecting answers to a first set of questions related to a given characteristic among said set of characteristics, a subset of categories from a set of categories which is associated with said given characteristic, wherein said answers to the first set of questions reflect information of said user; B. determining a set of exercises, based on said selected subset of categories.

In a second aspect of the present invention, there is provided a device for selecting exercises from a plurality of exercises for a user, each of said plurality of exercises being associated with a set of characteristics, and each characteristic of said set of characteristics being associated with a set of categories for classifying said plurality of exercises, the device comprising: a first unit for selecting, according to input reflecting answers to a first set of questions related to a given characteristic among said set of characteristics, a subset of categories from a set of categories which is associated with said given characteristic, wherein said answers to the first set of questions reflect information of said user; a second unit for determining a set of exercises, based on said selected subset of categories.

According to the above aspects, quantitative answers to clinical verified questions are utilized, and the selection of exercises is more accurate.

According to the above aspects, for a set of characteristics, such as the joint intended to be trained, a set of categories, such as shoulder joint, elbow joint and wrist joint, are used for classifying the plurality of exercises. The embodiment takes each category of exercises as a whole, and selects proper categories among the set of categories according to the answers to clinical verified questions; after that, the embodiment further selects proper exercises among those classified in the proper categories. The above aspects could help to obtain the proper exercises faster and more systematically than in the case of the technical solution of filtering each one of the plurality of exercises individually.

Advantageously, when the set of characteristics comprises at least two characteristics, for the method according to the first aspect of the present invention, said steps of selecting and determining use characteristics, of the at least two characteristics, not used previously, and repeat them at least one time in the set of exercises determined in the last step of determining, in order to determine a first subset of exercises. That is to say the set of exercises determined in each of the repeated steps of determining are selected and determined from the set of exercises determined in the last step of determining.

Accordingly, for the device according to the second aspect of the present invention, said first unit and said second unit use characteristics, of the at least two characteristics, not used previously, and repeat the selecting operation and determining operation at least one time in the set of exercises determined in the last determining operation executed by said second unit, in order to determine a first subset of exercises. That is to say the set of exercises determined in each operation of said second unit are selected and determined from among the set of exercises determined in the last operation of said second unit. These preferred embodiments are referred to as recursive iterations, and the exercises classified in proper categories are selected gradually according to different characteristics, and the selection is accelerated and more systematic.

Alternatively, instead of recursive iteration, said steps of selecting and determining use characteristics not used previously and repeat them at least one time in said plurality of exercises, in order to determine at least two sets of exercises. And the method further comprises the step of: determining a first subset of exercises from said at least two sets of exercises.

Accordingly, for the device according to the second aspect of the present invention, said first unit and said second unit use characteristics not used previously and repeat operations at least one time in said plurality of exercises, in order to determine at least two sets of exercises. And the device further comprises: a third unit for determining a first subset of exercises from said at least two sets of exercises. These preferred embodiments use different characteristics and select categories, each of which is suitable for one or more of these characteristics, then determine the exercises, suitable for all of these characteristics, from the selected categories, by, for example, determining the intersection of the sets of exercises in selected categories. The selection is accelerated and more systematic.

When, after categories are selected according to characteristics related to categories, and exercises, related to the selected categories, are determined, the determined exercises need to be checked individually according to some special inputs, the method according to the first aspect further comprises a step of selecting a second subset of exercises from the determined set of exercises or the determined first subset of exercises, according to inputs reflecting answers to a second set of questions, wherein said answers to said second set of questions are intended for individually excluding one or more exercises from said determined set of exercises or first subset of exercises. Accordingly, the device according to the second aspect of the present invention comprises a fourth unit for selecting a second subset of exercises from the determined set of exercises, according to inputs reflecting answers to a second set of questions; or it comprises a fifth unit for selecting a second subset of exercises from the first subset of exercises, according to inputs reflecting answers to a second set of questions. These preferred embodiments obtain individually suitable exercises, and thus provide the necessary information for the doctor or the therapist.

Advantageously, after the exercises are determined, the method according to the first aspect of the present invention comprises a step of: generating, for motor function rehabilitation for said user, training plan data including said determined exercises. Accordingly, the device according to the second aspect of the present invention further comprises a sixth unit for generating, for motor function rehabilitation for said user, training plan data including said determined exercises. This preferred embodiment provides the necessary information for the doctor or the therapist.

According to a preferred aspect, selecting categories is performed by comparing said input with first criteria, such as expert rules or domain knowledge for each of said set of categories. In this embodiment, the expert rules or domain knowledge could be used by all doctors and therapists, and this is especially helpful for those who are less skilled.

According to a third aspect of the present invention, there is provided an information medium storing a program which is loaded and executed by data processing devices to implement the method according to the first aspect of the present invention.

These and other features of the present invention will be described in detail in the embodiment part.

### BRIEF DESCRIPTION OF THE DRAWINGS

Features, aspects and advantages of the present invention will become apparent from the following description of non-limiting embodiments with reference to the appended drawings. In the drawings, same or similar reference numerals refer to the same or similar steps or means.

FIG. 1 is a block diagram of the device for selecting exercises, according to an embodiment of the present invention;

FIG. 2 is a flowchart of the method of selecting exercises, according to an embodiment of the present invention;

FIG. 3 shows the determined categories and exercises in each selection step, according to an embodiment of the present invention;

FIG. 4 is a block diagram of the device for selecting exercises, according to another embodiment of the present invention;

FIG. 5 shows the determined categories and exercises in each selection step, according to another embodiment of the present invention;

FIG. 6 is a block diagram of the device for selecting exercises, according to yet another embodiment of the present invention;

FIG. 7 shows the determined categories and exercises in each selection step, according to yet another embodiment of the present invention.

### DETAILED DESCRIPTION OF EMBODIMENTS

According to the invention, a method of selecting exercises from a plurality of exercises for a user is proposed. Each of said plurality of exercises is associated with a set of characteristics, and each characteristic of said set of characteristics is associated with a set of categories for classifying said plurality of exercises. The method comprises the steps of: A. selecting, according to input reflecting answers to a first set of questions related to a given characteristic among said set of characteristics, a subset of categories from a set of categories which is associated with said given characteristic, wherein said answers to the first set of questions reflects information of said user; B. determining a set of exercises based on said selected subset of categories.

According to the invention, a device for selecting exercises from a plurality of exercises for a user is proposed. Each of said plurality of exercises is associated with a set of characteristics, and each characteristic of said set of characteristics is associated with a set of categories for classifying said plurality of exercises. The device comprises: a first unit, for selecting, according to input reflecting answers to a first set of questions related to a given characteristic among said set of characteristics, a subset of categories from a set of categories which is associated with said given characteristic, wherein said answers to the first set of questions reflect information of said user; a second unit, for determining a set of exercises based on said selected subset of categories.

Herein, the characteristic represents the nature of one exercise in certain aspects, for example:

the requirement that the exercise is done independently;

the motion range of the body during the exercise;

the joints intended to be trained by the exercise;

the muscles intended to be trained by the exercise; etc.

To elucidate the invention, by way of example, the embodiment determines proper exercises, to be done by a user suffering from a stroke, from these 5 different available exercises. These exercises are listed in the following table 1:

TABLE 1

| No. | Exercise |
|---|---|
| E1 | Active shoulder flexion |
| E2 | Active shoulder extension |
| E3 | Active shoulder horizontal adduction |
| E4 | Self-assisted shoulder flexion |
| E5 | Active wrist palmar flexion and |
| | dorsiflexion with 90° flexion in the |
| | elbow combined with pronation |

Each of the exercises listed in table 1 is associated with two characteristics in a set of characteristics. The two characteristics are the joint intended to be trained and the requirement that said plurality of exercises are done independently, which can be either active, which means the user could do the exercise independently without external assistance, or self-assisted, which means the user needs assistance such as the arrangement of apparatus necessary to do the exercise.

For joints to be trained, there are two categories: C1 is for shoulder joints and C2 is for elbow and wrist joints. Each of the exercises E1, E2, E3 and E4 relates to C1, and exercise ES relates to C2. The categories and the exercises in each category are listed in the following table 2:

TABLE 2

| No. | Category | Exercises contained |
|---|---|---|
| C1 | Shoulder joint exercises | E1, E2, E3 and E4 |
| C2 | Elbow + wrist joint exercises | E5 |

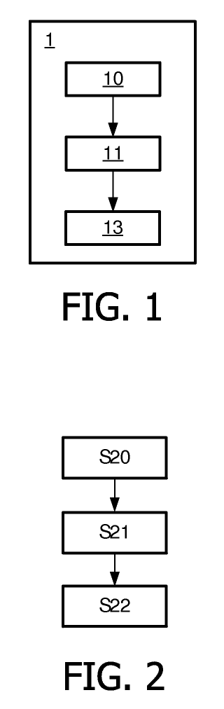

In the embodiment of the device according to the present invention, FIG. 1 shows a block diagram of the device 1 for selecting exercises. Device 1 comprises a first unit 10 and a second unit 11. Here, the device 1 is elucidated by way of functional units, while in practice, the device 1 can be implemented by way of either software, hardware or a combination thereof. For example, the program codes achieving the functions of the above functional units are stored in the memory. These codes are loaded and executed by a processor in a computer to implement the functions of device 1. For another example, certain IC chips achieve the functions of the above functional units, and these chips are controlled by a MCU to implement the function of device 1.

In an embodiment of the method according to the present invention, FIG. 2 shows a flowchart of the method of selecting exercises. In step S20, the first unit 10 selects, according to input reflecting answers to a first set of questions related to a given characteristic among said set of characteristics, e.g. the characteristic related to the joint to be trained, a subset of categories from the set of categories, i.e. categories C1 and C2.

The answers to the first set of questions reflect information of the user. The doctor or the therapist examines, tests or inquires the user according to the first set of questions, and inputs the answers corresponding to the evaluation results into device 1.

In this embodiment, the first set of questions may relate to a clinical scale of the user, for example a Modified Ashworth Scale (MAS). The MAS is used to evaluate the level of spasticity of the joints of the user. The doctor or the therapist scores the joints of the user using the MAS, and takes the scores as the answers to the first set of questions. For example, the shoulder joint is scored 1 in MAS, which indicates a slight increase in muscle tone, manifested by a catch and release or by minimal resistance at the end of the range of motion (ROM for short) when the affected part(s) is moved in flexion or extension. And dorsiflexion of the wrist joint is scored 3 in MAS, which indicates a considerable increase in muscle tone, passive movement being difficult. These scores are inputted by the doctor or the therapist via a user interface into the device 1.

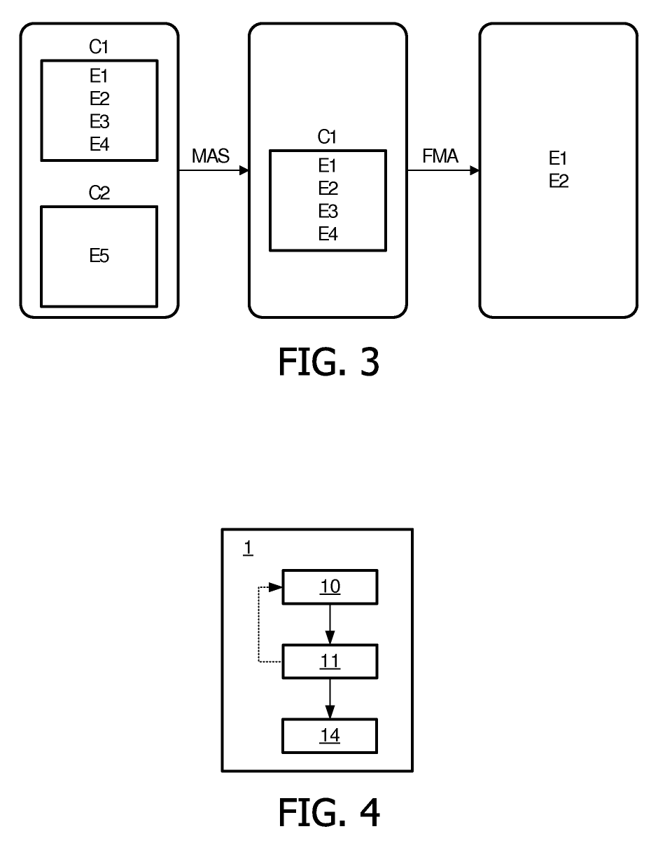

Advantageously, in step S20, the first unit 10 selects the subset of categories by comparing the input reflecting the answers to the first set of question with first criteria. The first criteria are used for indicating whether or not the user is capable of doing the exercises in each of the categories. The criteria could be inputted by the doctor or the therapist according to his experience; they may also be pre-stored as expert rules in the memory of the device 1 or a separate database. In the case of MAS, the first criterion for selecting category C1 is a MAS score in the shoulder joint of 2 or less than 2. And the first criterion for selecting category C2 is a MAS score in dorsiflexion of the wrist joint of 1 or less than 1. Then, in step S20, as shown in FIG. 3, the first unit 10 compares the MAS score of shoulder joint and wrist joint with the MAS scores required by categories C1 and C2. The first unit 10 selects category C1, because the measured score 1 of the user's shoulder joint complies with the first criterion, which indicates the condition of the user's shoulder joint is good enough for him to do the exercises for the shoulder joint in category C1. As for category C2, the measured score 3 does not comply with the criterion, which indicates that the condition of the user's elbow and wrist joint is not good enough for him to do the exercises for the elbow and wrist joint in category C2.

It is to be understood that the example is just for illustrating the principle of the invention, rather than for limiting the invention. From a set of categories, according to different criteria, the selected subset of categories may be only one category; it may also include more than one category. If none of the answers satisfy the criteria, then none of the categories can be selected. In this case, the device 1 outputs a prompt to indicate that the user should not do any one of exercises E1, E2, E3, E4 and ES.

Once the subset of categories is selected, in step S21, the second unit 11 determines a set of exercises, based on said selected subset of categories, being the set of exercises classified in the selected subset of categories. In the above example, the exercises E1 to E4 associated with category C1 are determined in step S21.

In an embodiment, the exercises determined by the second unit 11 need to be checked individually according to some special inputs, in order to exclude some exercises which the user is unable to do, and select those which the user is able to do. As shown in FIG. 1, the device 1 further comprises a fourth unit 13. The fourth unit 13 is used for selecting a second subset of exercises from the determined set of exercises, according to inputs reflecting answers to a second set of questions.

In this embodiment, the second set of questions relates to another clinical scale: Fugl Meyer Assessment (FMA). This scale is used for evaluating the user's capacity to perform some simple motions. The doctor or the therapist scores the user, using the FMA scale, and the obtained scores are the answers to the second set of questions. For example, the doctor or the therapist tests the user using item No. 13 of FMA “shoulder flexion to 90° with elbow at 0°”. And the user gets a score of 1, which indicates abduction or elbow flexion occurs in later phase of motion. This score is inputted into the device 1 via the user interface by the doctor or the therapist.

In step S22, the fourth unit 13 selects the exercises by comparing the input reflecting the answers to the set of questions with criteria. The criteria are used for indicating whether or not the user is capable of doing an exercise. The criteria could be inputted by the doctor or the therapist according to his experience; they may also be pre-stored as expert rules in the memory of the device 1 or a separate database. In the case of FMA, the required score in item 13 of FMA for selecting exercise E1 is 1 or more than 1, the required score in item 13 of FMA for selecting exercise E2 is 1 or more than 1, the required score in item 13 of FMA for selecting exercise E3 is 2 or more than 2, and the required score in item 13 of FMA for selecting exercise E4 is 2 or more than 2.

Therefore, as shown in FIG. 3, the fourth unit 13 selects exercises E1 and E2, because the measured scores of the user comply with the criteria of these two exercises, which indicates that the condition of the user's shoulder is good enough to perform these two exercises. The selected exercises E1 and E2 are intended to be included in a training plan for motor function rehabilitation of the user. The exercises E3 and E4 are excluded, because the measured score of the user does not comply with the criteria of exercises E3 and E4, which indicates that the condition of the user's shoulder is not good enough for him to do these two exercises.

In another embodiment, as shown in FIG. 4, when the set of characteristics comprises at least two characteristics, the first unit 10 and the second unit 11 use characteristics not used previously, and repeat their operations at least one time in the set of exercises determined in the last determining operation of the second unit 11, in order to determine a first subset of exercises. And the device 1 further comprises a fifth unit 14, for selecting a second subset of exercises from the first subset of exercises, according to inputs reflecting answers to a second set of questions, wherein the answers to the second set of questions reflect information of the user.

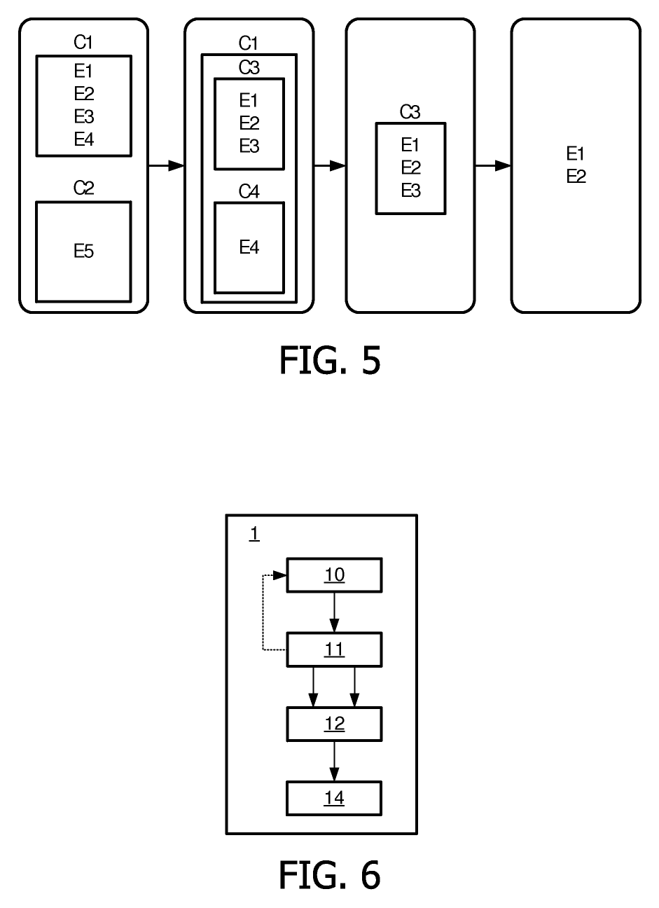

Specifically, as shown in FIG. 5, after the above steps S20 and S21, the characteristic of the requirement that the exercise is done independently, in the set of characteristics, not used previously, comprises two categories: C3 for active and C4 for self-assisted. For the set of exercises E1, E2, E3 and E4, determined in the last determining step S22 of the second unit 11, exercises E1, E2 and E3 associate with category C3 and exercise E4 associates with category C4. The categories and the exercises in each category are listed in the following table 3:

TABLE 3

| No. | Category | Exercises contained |
|---|---|---|
| C3 | Active | E1, E2 and E3 |
| C4 | Self-assisted | E4 |

As shown in FIG. 5, for the exercises E1, E2, E3 and E4, determined in the last determining step S22 of the second unit 11, the first unit 10 selects category C3 from categories C3 and C4, according to another scale related to the requirement that the categories of exercises are active or self-assisted.

Then, the second unit 11 determines the exercises E1, E2 and E3 which are associated with category C1.

It is to be understood that this embodiment is only for illustrating the principle of the invention. The operations of first unit 10 and second unit 11 may be repeated 1 or more times in order to decrease the number of determined exercises, according to the number of characteristics.

When the determined exercises after the recursive repetitions need to be checked individually according to some special inputs, the fifth unit 14 selects a second subset of exercises from the first subset of exercises, according to inputs reflecting answers to a second set of questions. Similarly, with step S22 performed by the fourth unit 13 in the above embodiment, the fifth unit 14 selects exercises E1 and E2, and excludes E3 from exercises E1, E2 and E3, according to a FMA scale. Details of the step S22 of fourth unit 13 have been elucidated in the above embodiment, therefore, a further description will not be given here.

The exercises classified in proper categories are selected gradually according to different characteristics, and the selection is accelerated and more systematic.

In yet another embodiment, the first unit 10 and the second unit 11 use characteristics not used previously and repeat operations at least one time in the plurality of exercises, in order to determine at least two sets of exercises. And the method further comprises the step of determining a first subset of exercises from the at least two sets of exercises. As shown in FIG. 6, the device further comprises a third unit 12, for determining a first subset of exercises from the at least two sets of exercises, and a fifth unit 14, for selecting a second subset of exercises from the first subset of exercises, according to inputs reflecting answers to a second set of questions, wherein the answers to the second set of questions reflect information of the user.

Specifically, besides the characteristic of the joint intended to be trained, the set of characteristics further comprises the characteristic of the requirement that the exercise is done independently. For this characteristic, there are two categories: C5 for active and C6 for self-assisted. The categories and the exercises in each category are listed in the following table 4:

TABLE 4

| No. | Category | Exercises contained |
|---|---|---|
| C5 | Active | E1, E2, E3 and E5 |
| C6 | Self-assisted | E4 |

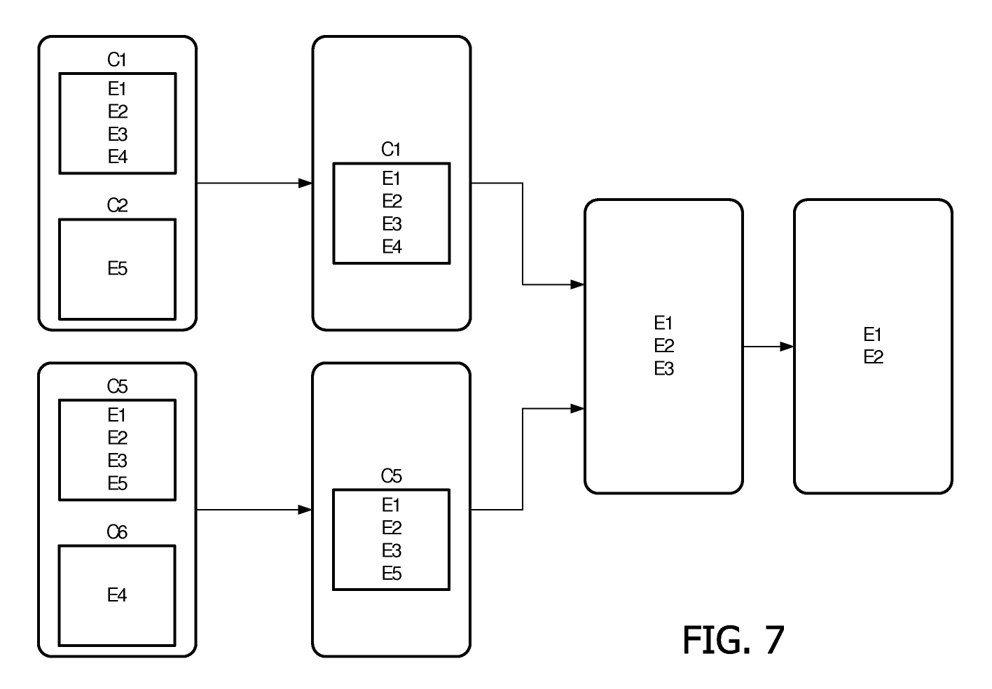

As shown in FIG. 7, for the exercises E1, E2, E3, E4 and E5, the first unit 10 selects category C5 from categories C5 and C6, according to another scale related to the requirement that the categories of exercises are done actively or self-assisted.

Then, the second unit 11 determines the exercises E1, E2, E3 and ES associated with category C5.

After that, the third unit 12 determines exercises E1, E2 and E3 from the exercises associated with both of the selected categories C1 and C5, which means that the intersection of the set of exercises in category C1 and the set of exercises in category C5 is taken as the first subset of exercises.

It is to be understood that this embodiment is only for illustrating the principle of the invention. According to the number of characteristics, the operations of first unit 10 and second unit 11 are repeated 1 or more times, and the two units determine at least two sets of exercises, and the third unit 12 determines the first subset of exercises from the at least two sets of exercises.

When, after the first subset of exercises, associated with all of the selected categories, is determined, the exercises in the first subset of exercises need to be checked individually according to some special inputs, the fifth unit 14 selects a second subset of exercises from the first subset of exercises, according to inputs reflecting answers to a second set of questions. Similarly, with the step S22 performed by the fourth unit 13 in the above embodiment, the fifth unit 14 selects exercises E1 and E2, and excludes E3 from exercises E1, E2 and E3, according to a FMA scale. Details of the step S22 of fourth unit 13 have been elucidated in the previous embodiment, therefore a further description will not be given here. This embodiment accelerates the selection and is more systematic.

In order to provide a comprehensive training plan, the selected exercises are intended to be included in a training plan for motor function rehabilitation for the user. The device 1 further comprises a sixth unit for generating, for motor function rehabilitation for the user, training plan data including the determined exercises. Specifically, the sixth unit further determines the number of exercises and the time when the user should do the exercises E1 and E2, thus generating training plan data comprising the exercises and related information such as number of exercises and time when the user should do the exercises.

As the user's health state update, the new scores in the scales could be measured and inputted into device 1 by the doctor or the therapist, and the device 1 would select proper categories and exercises according to the new scores.

It should be noted that the five exercises, the characteristics associated with each of the exercises, and the categories associated with each of the characteristics do not limit the present invention. In another example, the characteristic may be the motion range of a body member when the user performs the exercises, and the categories may comprise minor range, medium range and major range. In another example, the characteristic may be the target muscle intended to be trained by means of the exercises, and the categories may comprise biceps brachii, brachialis, pronator teres and brachioradialis. The doctor or the therapist could determine the associations between exercises and characteristics, and the associations between characteristics and categories, according to his knowledge. These and other(unmentioned) exercises, characteristics and categories are within the protective scope of the claims of the present invention.

It should also be noted that the MAS and FMA scales are used for elucidating the answers to questions related to a given characteristic, and they do not limit the present invention. The answers to questions related to a given characteristic may be used for evaluating:

1. the level of spasticity;

2. the level of pain;

3. the active range of movement of a joint;

4. the passive range of movement of a joint;

5. the level of functionality;

6. the level of independence;

7. the level of sensibility or sensation;

8. the level of mental state (or cognition);

9. the level of muscle strength.

And other scales or any kinds of suitable questions for evaluation proposed, are applicable for the present invention and are within the protective scope of the claims of the present invention. The doctor or the therapist could determine proper scales to be used.

The above embodiments focus on the fact that the present invention is applied for the selection of exercises for the training plan for motor function rehabilitation of a user after a stroke, but the present invention could also be used for selecting exercises for a training plan in sports, fitness or for losing weight. These and other (unmentioned) applications are within the protective scope of the claims of the present invention.

Although the embodiments of the present invention have been explained hereinabove in detail, it should be noted that the above-described embodiments are for the purpose of illustration only, and are not to be construed as a limitation of the invention. The present invention is not limited to these embodiments.

Those of ordinary skill in the art will be able to understand the invention and realize modifications to the disclosed embodiments, through studying the description, drawings and appended claims. All such modifications which do not depart from the spirit of the invention are intended to be included within the scope of the appended claims. The word “comprising” does not exclude the presence of elements or steps not listed in a claim or in the description. The word “a” or “an” preceding an element does not exclude the presence of a plurality of such elements. In the practice of the present invention, several technical features in the claims can be embodied by one component. In the claims, any reference signs placed between parentheses shall not be construed as limiting the claim.

1. A method of selecting exercises from a plurality of exercises for a user, each of said plurality of exercises being associated with a set of characteristics, and each characteristic of said set of characteristics being associated with a set of categories for classifying said plurality of exercises, the method comprising the steps of:
A. selecting, according to input reflecting answers to a first set of questions related to a given characteristic among said set of characteristics, a subset of categories from a set of categories which is associated with said given characteristic, wherein said answers to the first set of questions reflect information of said user;
B. determining a set of exercises, based on said selected subset of categories.

2. A method according to claim 1, wherein said set of characteristics comprises at least two characteristics, said steps of selecting and determining use characteristics, of the at least two characteristics, not used previously, and repeat them at least one time in the set of exercises determined in the last step of determining, in order to determine a first subset of exercises.

3. A method according to claim 1, wherein said set of characteristics comprises at least two characteristics, said steps of selecting and determining use characteristics, of the at least two characteristics, not used previously and repeat them at least one time in said plurality of exercises, in order to determine at least two sets of exercises;
the method further comprising the step of:
determining a first subset of exercises from said at least two sets of exercises.

4. A method according to claim 1, further comprising the step of:
selecting a second subset of exercises from the determined set of exercises, according to inputs reflecting answers to a second set of questions, wherein said answers to said second set of questions reflect information of said user.

5. A method according to claim 2, further comprising the step of:
selecting a second subset of exercises from the first subset of exercises, according to inputs reflecting answers to a second set of questions, wherein said answers to said second set of questions reflect information of said user.

6. A method according to claim 1, wherein said set of characteristics comprises at least one of the following:
the requirement that said plurality of exercise are done independently;
motion range;
joint intended to be trained;
muscle intended to be trained.

7. A method according to claim 1, wherein said selecting step is performed by comparing said input with first criteria.

8. A method according to claim 1, further comprising the step of:
generating, for motor function rehabilitation for said user, training plan data including said determined exercises.

9. A device for selecting exercises from a plurality of exercises for a user, each of said plurality of exercises being associated with a set of characteristics, and each characteristic of said set of characteristics being associated with a set of categories for classifying said plurality of exercises, the device comprising:
a first unit, for selecting, according to input reflecting answers to a first set of questions related to a given characteristic among said set of characteristics, a subset of categories from a set of categories which is associated with said given characteristic, wherein said answers to the first set of question reflects information of said user;
a second unit, for determining a set of exercises, based on said selected subset of categories.

10. A device according to claim 9, wherein said set of characteristics comprises at least two characteristics, said first unit and said second unit use characteristics, of the at least two characteristics, not used previously, and repeat the selecting operation and determining operation at least one time in the set of exercises determined in the last determining step executed by said second unit, in order to determine a first subset of exercises.

11. A device according to claim 9, wherein said set of characteristics comprises at least two characteristics, said first unit and said second unit use characteristics, of said at least two characteristics, not used previously and repeat the selecting operation and determining operation at least one time in said plurality of exercises, in order to determine at least two sets of exercises; the device further comprising:
a third unit, for determining a first subset of exercises from said at least two sets of exercises.

12. A device according to claim 9, further comprising:
a fourth unit, for selecting a second subset of exercises from the determined set of exercises, according to inputs reflecting answers to a second set of questions, wherein said answers to said second set of questions reflect information of said user.

13. A device according to claim 10, further comprising:
a fifth unit, for selecting a second subset of exercises from the first subset of exercises, according to inputs reflecting answers to a second set of questions, wherein said answers to said second set of questions reflect information of said user.

14. A device according to claim 9, wherein said device further comprises:
a sixth unit for generating, for motor function rehabilitation for said user, training plan data including said determined exercises.

15. An information medium, storing a program which is loaded and executed by data processing devices to implement a method according to claim 1.
